(19) United States
(12) Patent Application Publication
(10) Pub. No.: US 2023/0004902 A1
(43) Pub. Date: Jan. 5, 2023

(54) VALUE ELEMENT EVALUATION APPARATUS, VALUE ELEMENT EVALUATION METHOD AND PROGRAM

(71) Applicant: Nippon Telegraph and Telephone Corporation, Tokyo (JP)

(72) Inventors: Machiko SHINOZUKA, Musashino-shi, Tokyo (JP); Takashi FURUTANI, Musashino-shi, Tokyo (JP); Akira TAKEUCHI, Musashino-shi, Tokyo (JP); Xiaoxi ZHANG, Musashino-shi, Tokyo (JP); Yuriko TANAKA, Musashino-shi, Tokyo (JP)

(21) Appl. No.: 17/782,763

(22) PCT Filed: Dec. 6, 2019
(86) PCT No.: PCT/JP2019/047946

§ 371 Date: Jun. 6, 2022

(51) Int. Cl. G06Q 10/06

(52) U.S. Cl. CPC G06Q 10/06313

(57) ABSTRACT

A value element determination device according to an embodiment includes: an input unit for inputting a function of an evaluation target service and a standpoint of a user using the evaluation target service; a first calculation unit that uses a relevance matrix having relevance between the function of the evaluation target service and each of state-changes of the user using the evaluation target service as elements to calculate the relevance between the function input via the input unit and each of the state-changes; an acquisition unit that acquires, from a database storing sets of the state-change of the user using the evaluation target service and advantage or disadvantage of the user using the evaluation target service, a set including a state-change having the relevance calculated by the first calculation unit exceeding a threshold value; a second calculation unit that calculates similarity in terms of meanings of the advantage or disadvantage included in the set acquired by the acquisition unit, the standpoint of the user input via the input unit, and an evaluation element representing an element configuring evaluation of the evaluation target service; and an output unit that outputs the evaluation element having the similarity calculated by the second calculation unit exceeding the threshold value.

### TECHNICAL FIELD

The present invention relates to a value element determination device, a value element determination method, and a program thereof.

### BACKGROUND ART

Recently, due to adoption of the Paris Agreement, the Sustainable Development Goals (SDG), and the like, companies are required to tackle environmental and social issues. Therefore, an idea of “Creating Shared Value (CSV)” that is to work on solving the environmental and social issues through their main businesses is being spread in corporate management, and many companies are working on developing products and services that have both economic value (profitability, value for customers, and the like) and social value.

In order to develop an “Information and Communication Technology (ICT)” service having both economic value and social value, it is necessary to visualize the values and social contribution of the ICT service. While evaluations of the contributions and environmental influences of the ICT services for the SDGs have been conducted heretofore, there has been no method established for visualizing the values.

Note that Non-Patent Literature 1 discloses a technique for deriving value elements of a game by interviewing users and using a laddering method.

### CITATION LIST

### Non-Patent Literature

Non-Patent Literature 1: Yu-Ling Lin et al., “Players' Value Structure in Digital Games”, Games and Culture, vol. 12, NO. 1, pp. 72-99, 2017

### SUMMARY OF THE INVENTION

### Technical Problem

As described above, there has been no method established heretofore for visualizing the values of the ICT services (that is, for determining what kind of value elements the ICT services provide and visualizing the value elements).

It is considered to apply the technique disclosed in Non-Patent Literature 1 to the ICT services. In that case, however, it is necessary to have interviews every time for each of the services. Therefore, it is considered that a great amount of work and effort is required for determining value elements of a plurality of services.

An embodiment of the present invention is designed in view of the foregoing aspect, and an object thereof is to present value elements of ICT services.

### Means for Solving the Problem

In order to achieve the aforementioned object, a value element determination device according to an embodiment includes: an input unit for inputting a function of an evaluation target service and a standpoint of a user using the evaluation target service; a first calculation unit that uses a relevance matrix having relevance between the function of the evaluation target service and each of state-changes of the user using the evaluation target service as elements to calculate the relevance between the function input via the input unit and each of the state-changes; an acquisition unit that acquires, from a database storing sets of the state-change of the user using the evaluation target service and advantage or disadvantage of the user using the evaluation target service, a set including a state-change having the relevance calculated by the first calculation unit exceeding a threshold value; a second calculation unit that calculates similarity in terms of meanings of the advantage or disadvantage included in the set acquired by the acquisition unit, the standpoint of the user input via the input unit, and an evaluation element representing an element configuring evaluation of the evaluation target service; and an output unit that outputs the evaluation element having the similarity calculated by the second calculation unit exceeding the threshold value.

### Effects of the Invention

It is possible to present the value elements of the ICT services.

### BRIEF DESCRIPTION OF DRAWINGS

FIG. 1 is a diagram illustrating an example of an entire configuration of a value element determination device according to an embodiment.

FIG. 2 is a chart illustrating an example of a relevance matrix.

FIG. 3 is a table illustrating examples of a set stored in a state-change and advantage/disadvantage DB.

FIG. 4 is a table illustrating examples of a value element stored in a value element storage unit.

FIG. 5 is a flowchart illustrating an example of value element determination processing according to the embodiment.

FIG. 6 is a diagram illustrating an example of an input screen.

FIG. 7 is a diagram illustrating an example of a hardware configuration of the value element determination device according to the embodiment.

### DESCRIPTION OF EMBODIMENT

Hereinafter, an embodiment of the present invention will be described. In the embodiment, described is a value element determination device 10 that is capable of determining value elements of an ICT service and presenting the value elements. The use of the value element determination device 10 according to the embodiment makes it possible to determine value elements of various ICT services universally without having interviews and the like of users, for example. Therefore, it is also possible to reduce the work and effort required for having interviews for determining the value elements of the ICT service, for example. Furthermore, since various ICT services can be evaluated with common value elements, for example, it is also possible to achieve improvement and the like of the services based on the evaluation result (for example, a value element missing in a certain ICT service can be implemented by combining a plurality of ICT services).

Entire Configuration

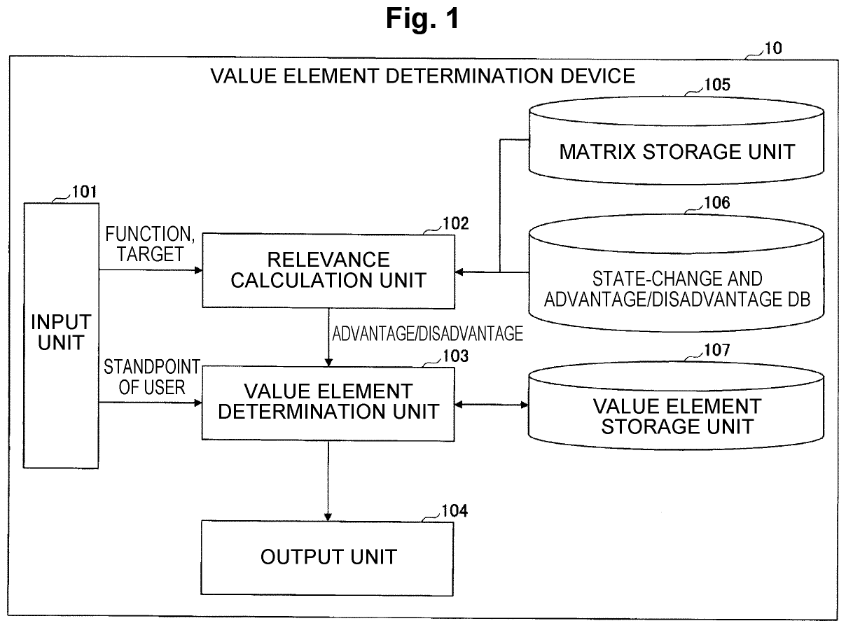

First, the entire configuration of the value element determination device 10 according to the embodiment will be described by referring to FIG. 1. FIG. 1 is a diagram illustrating an example of the entire configuration of the value element determination device 10 according to the embodiment.

As illustrated in FIG. 1, the value element determination device 10 according to the embodiment includes an input unit 101, a relevance calculation unit 102, a value element determination unit 103, an output unit 104, a matrix storage unit 105, a state-change and advantage/disadvantage DB 106, and a value element storage unit 107.

The input unit 101 receives input related to functions of an ICT service, targets of the ICT service, standpoints of users, and threshold values used for determination and the like of value elements. Those functions, target, standpoint, and threshold value are input on a prescribed input screen by a selection operation, an input operation, or the like of the user of the value element determination device 10. Note here that the functions of the ICT service are the functions provided to the user as the ICT service, and examples thereof may be “measurement/visualization”, “analysis”, “control”, “accumulation”, and the like. The targets of the ICT service are the targets of the functions, and examples thereof may be “sensor data”, “content”, “alert”, and the like. The standpoints of the users are the classifications and the like of the users who use the ICT service, and examples thereof may be “consumer”, “business person”, and the like.

For example, in a case where the ICT service is a “service for accumulating content”, the function is “accumulation” and the target is “content”. Similarly, in a case where the ICT service is a “service for measuring and visualizing sensor data”, for example, the function is “measurement/visualization” and the target is “sensor data”. As described, in a sentence simply explaining the ICT service, the function corresponds to a verb while the target corresponds to an object.

The relevance calculation unit 102 uses a relevance matrix stored in the matrix storage unit 105 to calculate the relevance between the function input via the input unit 101 and the state-change of the user. Furthermore, the relevance calculation unit 102 uses the state-change whose calculated relevance exceeds a threshold value to acquire a set including the state-change from the sets (sets of state-change and advantage/disadvantage) stored in the state-change and advantage/disadvantage DB 106.

Furthermore, when a plurality of sets are acquired from the state-change and advantage/disadvantage DB 106, the relevance calculation unit 102 calculates the similarity in terms of the meanings of the state-change included in those sets and the target corresponding to the function input via the input unit 101, and extracts the set whose calculated similarity exceeds the threshold value.

Note here that the state-change is the change in the state of the user occurred by using the function of the ICT service, and examples thereof may be “coming to know tendency”, “becoming aware of abnormality”, and the like. Furthermore, the advantage/disadvantage is the advantage or the disadvantage caused for the user due to the state-change, and examples thereof may be “being able to make appropriate plan”, “being able to deal with abnormality”, and the like.

For example, in a case where the ICT service is the “service for measuring and visualizing sensor data”, the state-change of the user regarding the ICT service may be “coming to know tendency”, and the advantage/disadvantage may be “being able to make plan appropriately”. Similarly, in a case where the ICT service is a “service for issuing alert”, for example, the state-change of the user regarding the ICT service may be “becoming aware of abnormality”, and the advantage/disadvantage may be “being able to deal with abnormality”.

The value element determination unit 103 uses the advantage/disadvantage included in the set acquired or extracted by the relevance calculation unit 102, the standpoint input via the input unit 101, and the value element stored in the value element storage unit 107 to calculate the similarity in terms of the meanings of the advantage/disadvantage, the standpoint, and the value element. Furthermore, the value element determination unit 103 acquires the value element whose calculated similarity exceeds the threshold value from the value element storage unit 107. Note here that a value element is an element configuring the value implemented by the use of the ICT service, and examples thereof may be “saving time”, “relieving anxiety”, “providing connections”, and the like.

The output unit 104 outputs the value element acquired by the value element determination unit 103. Output destinations of the output unit 104 may be determined arbitrarily. For example, the value element may be output to a display to be displayed or may be output to a speaker to be output by voice.

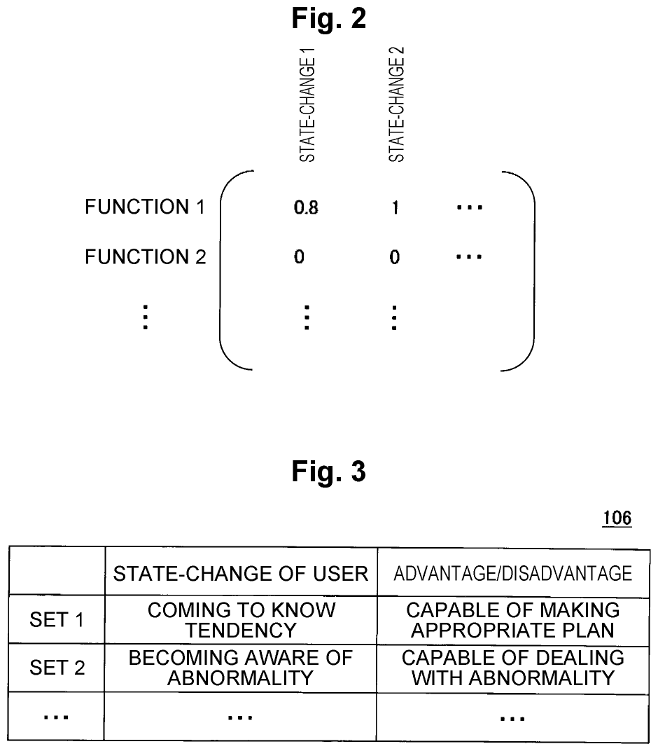

In the matrix storage unit 105, a relevance matrix having the relevance between the function and the state-change as the element is stored. An example of the relevance matrix stored in the matrix storage unit 105 is illustrated in FIG. 2. FIG. 2 is a chart illustrating an example of the relevance matrix.

As illustrated in FIG. 2, in the relevance matrix, rows are the functions while columns are the state-changes, for example. Furthermore, the relevance matrix takes the relevance between the function corresponding to the row and the state-change corresponding to the column as the element of the corresponding row and column. Note that the element is a value of 0 to 1, both inclusive.

In the example illustrated in FIG. 2, the element at (1, 1) of the relevance matrix indicates that the relevance between function 1 and state-change 1 is 0.8. Similarly, the element at (1, 2) of the relevance matrix indicates that the relevance is 1.

As described, the relevance matrix is a matrix having the relevance between each function and each state-change as an element. As the relevance thereof, cooccurrence probability, cosine similarity, or the like may be used, or values set manually by an evaluator or the like who evaluates the ICT service may be used as well. Note that each element (that is, relevance) of the relevance matrix is determined only by the function and the state-change and not affected by other information (for example, the target of the ICT service, the standpoint of the user, and the like). This is because the relevance calculation unit 102 first narrows down the advantage/disadvantage from the relation between the function and the state-change as described above.

In the state-change and advantage/disadvantage DB 106, sets of the state-change of the user and the advantage/disadvantage are stored. Note here that examples of the sets stored in the state-change and advantage/disadvantage DB 106 are illustrated in FIG. 3. FIG. 3 is a table illustrating examples of the sets stored in the state-change and advantage/disadvantage DB 106.

As illustrated in FIG. 3, one or more sets are stored in the state-change and advantage/disadvantage DB 106, and each set includes the state-change of the user and the advantage/disadvantage.

In the example illustrated in FIG. 3, the state-change of the user “coming to know tendency” and the advantage/disadvantage “being able to make appropriate plan” are included in set 1. Similarly, the state-change of the user “becoming aware of abnormality” and the advantage/disadvantage “being able to deal with abnormality” are included in set 2.

As described, sets of the state-change of the user and the advantage/disadvantage are stored in the state-change and advantage/disadvantage DB 106. The sets stored in the state-change and advantage/disadvantage DB 106 are generated independently from the standpoints of the user and the targets of the ICT service.

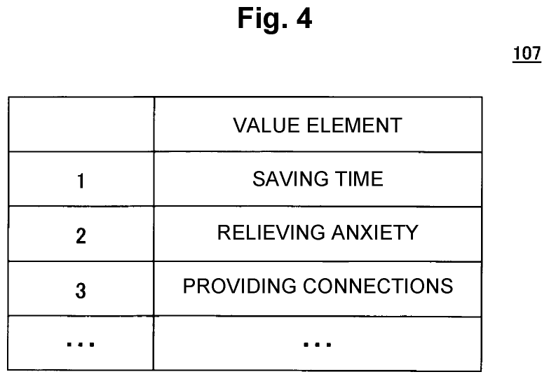

In the value element storage unit 107, one or more value elements are stored. Note here that examples of the value elements stored in the value element storage unit 107 are illustrated in FIG. 4. FIG. 4 is a table illustrating examples of the value elements stored in the value element storage unit 107.

As illustrated in FIG. 4, one or more value elements are stored in the value element storage unit 107. In the example illustrated in FIG. 4, “saving time”, “relieving anxiety”, “providing connections” and the like are stored as the value elements.

As described, in the value element storage unit 107, the value elements constituting the values implemented by the use of the ICT service are stored. The value of the ICT service is expressed by the one or more value elements. Other specific examples of the value elements may be “reducing risk”, “managing health”, “providing information”, and “reducing effort”.

Value Element Determination Processing

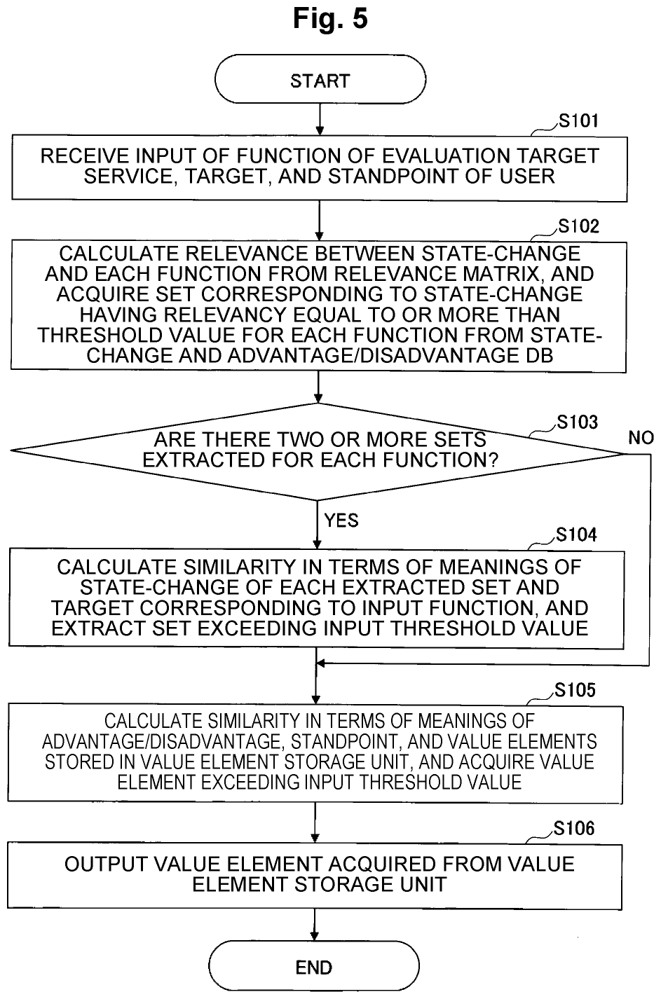

Hereinafter, processing for determining the value elements of the ICT service (value element determination processing) by the value element determination device 10 according to the embodiment will be described by referring to FIG. 5. FIG. 5 is a flowchart illustrating an example of the value element determination processing according to the embodiment.

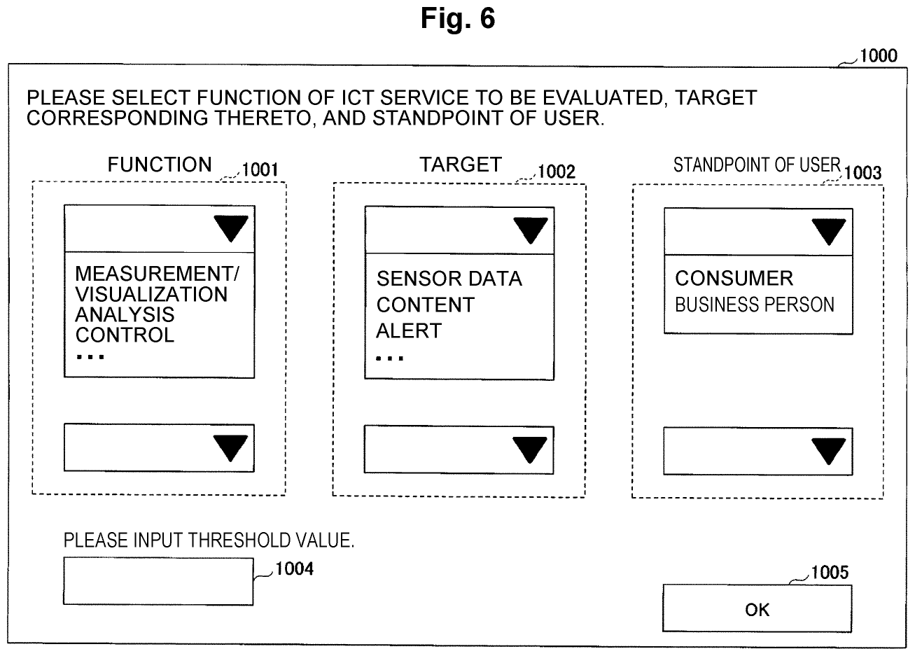

Step S101: First, the input unit 101 receives input of the function of the ICT service as the evaluation target, the target of the ICT service, the standpoint of the user, and the threshold values used for determination and the like of the value elements. Those function, target, standpoint and threshold value are input on an input screen 1000 illustrated in FIG. 6, for example, by a selection operation, an input operation, or the like performed by the user of the value element determination device 10.

On the input screen 1000 illustrated in FIG. 6, included are an ICT service function selection section 1001, an ICT service target selection section 1002, a user standpoint selection section 1003, a threshold value input section 1004, and an OK button 1005. As for the ICT service function selection section 1001, the ICT service target selection section 1002, and the user standpoint selection section 1003, a pulldown list of options that can be selected by an operation of the user is displayed. The user of the value element determination device 10 can select the function, the target, and the standpoint of the user by selecting a desired option from the list of options pulldown-displayed in each of the ICT service function selection section 1001, the ICT service target selection section 1002, and the user standpoint selection section 1003.

Furthermore, the user can input the threshold value used for determining the value element by inputting an arbitrary value of 0 to 1, both inclusive, to the threshold value input section 1004. As for the threshold value input section 1004, a desired threshold value may also be selected from a list of options.

When the OK button 1005 is pressed by the user, information selected or input in each of the ICT service function selection section 1001, the ICT service target selection section 1002, the user standpoint selection section 1003, and the threshold value input section 1004 is entered via the input unit 101.

Note that as for the ICT service function selection section 1001, the ICT service target selection section 1002, and the user standpoint selection section 1003, there may be a plurality of sections included, respectively, on the input screen 1000 illustrated in FIG. 6. That is, a plurality of function selection sections 1001, a plurality of target selection sections 1002, and a plurality of standpoint selection sections 1003 may be included regarding a certain single ICT service. In that case, the user of the value element determination device 10 can select a plurality of functions, targets, and standpoints of the user, respectively, regarding the certain single ICT service.

Furthermore, in regards to each of a plurality of ICT services, for example, one or more function selection sections 1001, one or more target selection sections 1002, and one or more standpoint selection sections 1003 may be included. In that case, the user of the value element determination device 10 can select one or more functions, targets, and standpoints of the user, respectively, regarding each of the plurality of ICT services. In that case, the threshold value input section 1004 may be included for each of the plurality of ICT services.

Step S102: Next, the relevance calculation unit 102 uses the relevance matrix stored in the matrix storage unit 105 to calculate the relevance between the function input and received at step S101 described above and the state-change of the user. That is, for example, when the function input and received at step S101 described above is “function n”, the relevance calculation unit 102 acquires the value of each element on the row corresponding to the function n from the relevance matrix to calculate the relevance between the function n and each of the state-changes, respectively. In a case where a plurality of functions are input and received at step S101 described above, the relevance calculation unit 102 calculates, for each of the functions, the relevance between the function and each of the state-changes, respectively.

Then, among the calculated relevance, the relevance calculation unit 102 uses the state-change having the calculated relevance exceeding the threshold value input and received at step S101 described above to acquire the set (set of the state-change and the advantage/disadvantage) including that state-change from the state-change and advantage/disadvantage DB 106. Thereby, the set of the state-change and the advantage/disadvantage is acquired for each of the functions input and received at step S101 described above.

Step S103: The relevance calculation unit 102 determines whether there are two or more sets acquired at step S102 described above for each of the functions input and received at step S101 described above.

For the function for which two or more sets are acquired at step S102 described above, step S104 to be described later is executed. Meanwhile, step S104 is not executed for the function for which there is a single set acquired at step S102 described above.

Step S104: The relevance calculation unit 102 calculates similarity in terms of the meanings of the state-change included in the set and the target (target corresponding to the function) input and received at step S101 described above for each of the sets acquired at step S102 described above. That is, in a case where a plurality of sets are acquired for the function n at step S102 described above, for example, the relevance calculation unit 102 calculates the similarity in terms of the meanings of the state-change included in the set and the target corresponding to the function n input and received at step S101 described above for each of the plurality of sets.

Note here that the similarity in terms of the meanings is the similarity between the meanings of sentences or words, which may be calculated by a method of natural language processing. For such a method, it is possible to use a method disclosed in a reference literature by OKAZAKI Naoaki, “Frontiers in Distributed Representations for Natural Language Processing”, Artificial Intelligence, pp. 189-201, 2016.

More specifically, the relevance calculation unit 102 decomposes each of the state-change and the target into morphemes (words) by morphological analysis, and then acquires a vector representation of each of the state-change and the target by word2vec or the like pretrained by corpus or the like. Then, the relevance calculation unit 102 calculates the distance between the vector representing the state-change and the vector representing the target as the similarity. As the distance (similarity), cosine similarity or the like may be used, for example.

Thereafter, the relevance calculation unit 102 extracts the set whose calculated similarity exceeds the threshold value input and received at step S101 described above. When there are a plurality of sets whose similarity exceeds the threshold value, the plurality of sets are extracted.

Step S105: For each of the functions input and received at step S101 described above, the value element determination unit 103 uses following advantage/disadvantage, following standpoint, and each of following value elements to calculate the similarity in terms of the meanings of the advantage/disadvantage, standpoint, and each of the value elements, respectively. Note here that the following advantage/disadvantage is the advantage/disadvantage acquired at step S103 described above or included in the set extracted at step S104 described above. Furthermore, the following standpoint is the standpoint (standpoint of the user corresponding to the respective function) input and received at step S101 described above. Furthermore, each of the following value elements is each of the value elements stored in the value element storage unit 107.

Note here that the value element determination unit 103 may calculate the similarity in terms of the meanings of the advantage/disadvantage, the standpoint, and each of the value elements, respectively, by the method of step S104 described above. At this time, the value element determination unit 103 may perform morphological analysis and conversion to a vector representation of a sentence in which the advantage/disadvantage and the standpoint are connected.

Then, the value element determination unit 103 acquires the value element whose calculated similarity exceeds the threshold value input and received at step S101 described above from the value element storage unit 107. When there are a plurality of value elements whose similarity exceeds the threshold value, the plurality of value elements are acquired.

Step S106: At last, the output unit 104 outputs the value element acquired at step S105 described above for each of the functions input and received at step S101 described above. Thereby, the value elements of each of the ICT services are output, respectively.

Hardware Configuration

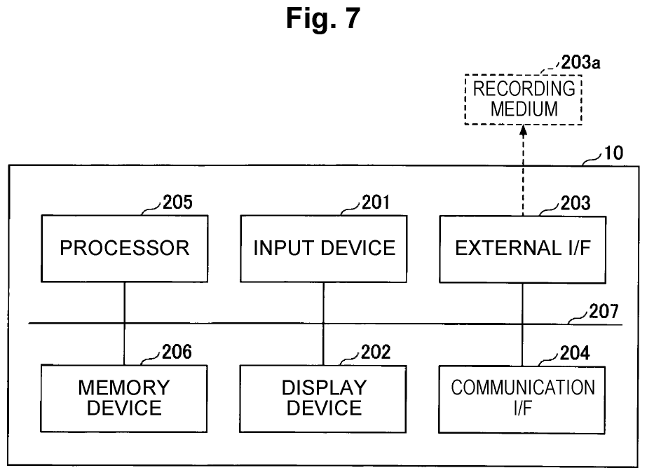

Finally, the hardware configuration of the value element determination device 10 according to the embodiment will be described by referring to FIG. 7. FIG. 7 is a diagram illustrating an example of the hardware configuration of the value element determination device 10 according to the embodiment.

As illustrated in FIG. 7, the value element determination device 10 according to the embodiment is implemented by a typical computer or computer system, and includes an input device 201, a display device 202, an external I/F 203, a communication I/F 204, a processor 205, and a memory device 206. Each piece of such hardware is connected mutually in a communicable manner via a bus 207.

The input device 201 may be a keyboard, a mouse, a touch panel, or the like, for example. The display device 202 may be a display or the like, for example.

The external I/F 203 is an interface with external devices. As the external device, there may be a recording medium 203a, or the like. The value element determination device 10 is capable of performing reading, writing, and the like from/to the recording medium 203a via the external I/F 203. In the recording medium 203a, one or more programs for implementing each of the functional units (the input unit 101, the relevance calculation unit 102, the value element determination unit 103, the output unit 104, and the like) provided to the value element determination device 10, for example, may be stored.

As the recording medium 203a, there are a Compact Disc (CD), a Digital Versatile Disk (DVD), a Secure Digital memory card (SD memory card), a Universal Serial Bus (USB) memory card, and the like, for example.

The communication I/F 204 is an interface for connecting the value element determination device 10 to a communication network. Note that the one or more programs for implementing each of the functional units of the value element determination device 10 may be acquired (downloaded) from a prescribed server device or the like via the communication I/F 204. Furthermore, it is also possible to provide the one or more programs for implementing each of the functional units of the value element determination device 10 to a prescribed device via the communication I/F 204.

Examples of the processor 205 may be a various kinds of calculation units such as a Central Processing Unit (CPU), and a Graphic Processing Unit (GPU). Each of the functional units of the value element determination device 10 is implemented by processing executed by the processor 205 caused by the one or more programs stored in the memory device 206 or the like, for example.

Examples of the memory device 206 may be a various kinds of memory devices such as a Hard Disk Drive (HDD), a Solid State Drive (SSD), a Random Access Memory (RAM), a Read Only Memory (ROM), and a flash memory. Each of the storage units (the matrix storage unit 105, the state-change and advantage/disadvantage DB 106, the value element storage unit 107, and the like) of the value element determination device 10 can be implemented by using the memory device 206. For example, at least one of those storage units may be implemented by using a storage device or the like connected to the value element determination device 10 via the communication network.

The value element determination device 10 according to the embodiment can implement the value element determination processing described above by having the hardware configuration illustrated in FIG. 7. Note that the hardware configuration illustrated in FIG. 7 is an example, and the value element determination device 10 may have other hardware configuration. For example, the value element determination device 10 may include a plurality of processors 205 and may include a plurality of memory devices 206.

The present invention is not limited by the embodiment disclosed specifically, and various modifications and changes as well as combination and the like with known techniques are possible without departing from the scope of the appended claims.

### REFERENCE SIGNS LIST

10 Value element determination device

101 Input unit

102 Relevance calculation unit

103 Value element determination unit

104 Output unit

105 Matrix storage unit

106 State-change and advantage/disadvantage DB

107 Value element storage unit

1. A value element determination device comprising:
an input unit, implemented by one or more computers, configured to receive a function of an evaluation target service and a standpoint of a user using the evaluation target service;
a first calculation unit, implemented by one or more computers, configured to use a relevance matrix having relevance between the function of the evaluation target service and state-changes of the user using the evaluation target service as elements to calculate relevance between the function and the state-changes;
an acquisition unit, implemented by one or more computers, configured to acquire, from a database storing sets of the state-changes of the user using the evaluation target service and an advantage or disadvantage of the user using the evaluation target service, one or more of the sets of the state-changes of the user as an acquired set that includes a state-change having the relevance calculated by the first calculation unit that exceeds a threshold value;
a second calculation unit, implemented by one or more computers, configured to calculate a similarity of the advantage or disadvantage included in the acquired set, the standpoint of the user, and an evaluation element representing an element of the evaluation target service; and
an output unit, implemented by one or more computers, configured to output the evaluation element having the similarity calculated by the second calculation unit that exceeds the threshold value.

2. The value element determination device according to claim 1, wherein:
the input unit is configured to receive input of a target of the function;
when the acquired set includes a plurality of the sets of the state-changes of the user, the first calculation unit is configured to calculate the similarity of the state-changes included in each of the plurality of the sets of the state-changes of the user and the target;
the acquisition unit is configured to extract, from the plurality of the sets of the state-changes of the user, the set of the state-changes of the user having the similarity calculated by the first calculation unit exceeding the threshold value as an extracted set; and
the second calculation unit is configured to calculate the similarity of the advantage or disadvantage included in the extracted set, the standpoint of the user, and the evaluation element.

3. The value element determination device according to claim 1, wherein the second calculation unit is configured to calculate the similarity in terms of sentence meanings in which the advantage or disadvantage and the standpoint are connected and a sentence indicated by the evaluation element.

4. The value element determination device according to claim 1, wherein the evaluation target service is an ICT service.

5. A value element determination method for a computer to execute:
an input process, implemented by one or more computers, that receives input of a function of an evaluation target service and a standpoint of a user using the evaluation target service;
a first calculation process, implemented by one or more computers, that uses a relevance matrix having relevance between the function of the evaluation target service and state-changes of the user using the evaluation target service as elements to calculate relevance between the function and the state-changes;
an acquisition process, implemented by one or more computers, that acquires, from a database storing sets of the state-changes of the user using the evaluation target service and an advantage or disadvantage of the user using the evaluation target service, one or more of the sets of the state-changes of the user as an acquired set that includes a state-change having the relevance calculated by the first calculation process that exceeds a threshold value;
a second calculation process, implemented by one or more computers, that calculates a similarity of the advantage or disadvantage included in the acquired set, the standpoint of the user, and an evaluation element representing an element of the evaluation target service; and
an output process, implemented by one or more computers, that outputs the evaluation element having the similarity calculated by the second calculation process that exceeds the threshold value.

6. (canceled)

7. A non-transitory, computer-readable medium storing one or more instructions executable by a computer system to perform operations by a value element determination device comprising:
receiving, by an input unit, a function of an evaluation target service and a standpoint of a user using the evaluation target service;
calculating, by a first calculation unit configured to use a relevance matrix having relevance between the function of the evaluation target service and state-changes of the user using the evaluation target service as elements, relevance between the function and the state-changes;
acquiring, by an acquisition unit configured to acquire, from a database storing sets of the state-changes of the user using the evaluation target service and advantage or disadvantage of the user using the evaluation target service, one or more of the sets of the state-changes of the user as an acquired set that includes a state-change having the relevance calculated by the first calculation unit that exceeds a threshold value;
calculating, by a second calculation unit configured to calculate a similarity of the advantage or disadvantage included in the acquired set, the standpoint of the user, and an evaluation element representing an element configuring evaluation of the evaluation target service; and
outputting, by an output unit, the evaluation element having the similarity calculated by the second calculation unit that exceeds the threshold value.
